(19) United States
(12) Patent Application Publication
(10) Pub. No.: US 2007/0000095 A1
(43) Pub. Date: Jan. 4, 2007

(54) Soft handle (II)

(76) Inventor: Michael Chien-Lung Wu, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/171,442

(22) Filed: Jul. 1, 2005

(51) Int. Cl. B25G 1/10

(52) U.S. Cl. 16/430

(57) ABSTRACT

The invention relates to a soft handle, which includes a soft shell, a special shaft having several slots, and an upper connecting rod. A bottom cap is provided to connect with lower end of the shaft to seal the shell, while the inner space of the shell is fulfilled with sticky liquid. The handle will be therefore really soft for facilitating use when connecting other products.

### FIELD OF THE INVENTION

The present invention relates to a soft handle, which includes a soft shell connecting with an inner shaft. And inner space of the shell is fulfilled with sticky liquid to provide a soft character for handling.

### BACKGROUND OF THE INVENTION

There are many products having a handle for facilitating users to hold, such as umbrellas, hair driers, and combs. The traditional handle always has a hard handle with a fixed shape. After a long time using, users feel uncomfortable usually. Although the known handle sometimes has a rubber cover, it is still not comfortable for long time use.

### SUMMARY OF THE INVENTION

The present invention is to provide a soft handle, which includes a soft shell connecting with a specific shaft and a connecting rod, and being fulfilled with sticky liquid inside to form a really soft handle for comfortable use. Now, accompanying with the following drawings, the character of the present invention will be described here and after.

### BRIEF DESCRIPTION OF THE DRAWINGS

FIG. 1 is a perspective view showing a soft handle according to the present invention.

FIG. 2 is an exploded perspective view of FIG. 1.

FIGS. 3 to 5 show the cross-sectional views of assembling procedures of FIG. 2.

FIG. 6 is a plan view showing the soft handle applied on an umbrella.

FIG. 7 is a plan view showing the soft handle applied on a comb.

FIG. 8 is a plan view showing the soft handle applied on a hair drier.

FIG. 9 is a plan view showing a modified structure of the soft handle according to the present invention.

FIG. 10 is a plan view showing the soft handle applied on a brief case.

FIGS. 11 and 12 are plan views showing other modified structures of the soft handle according to the present invention.

### DETAILED DESCRIPTION OF THE PREFERRED EMBODIMENT

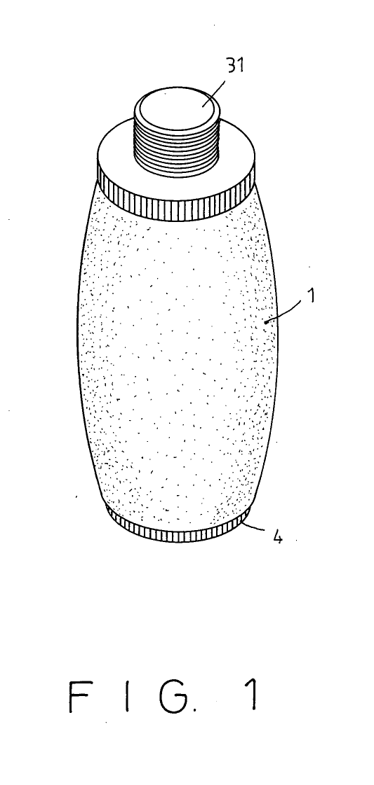

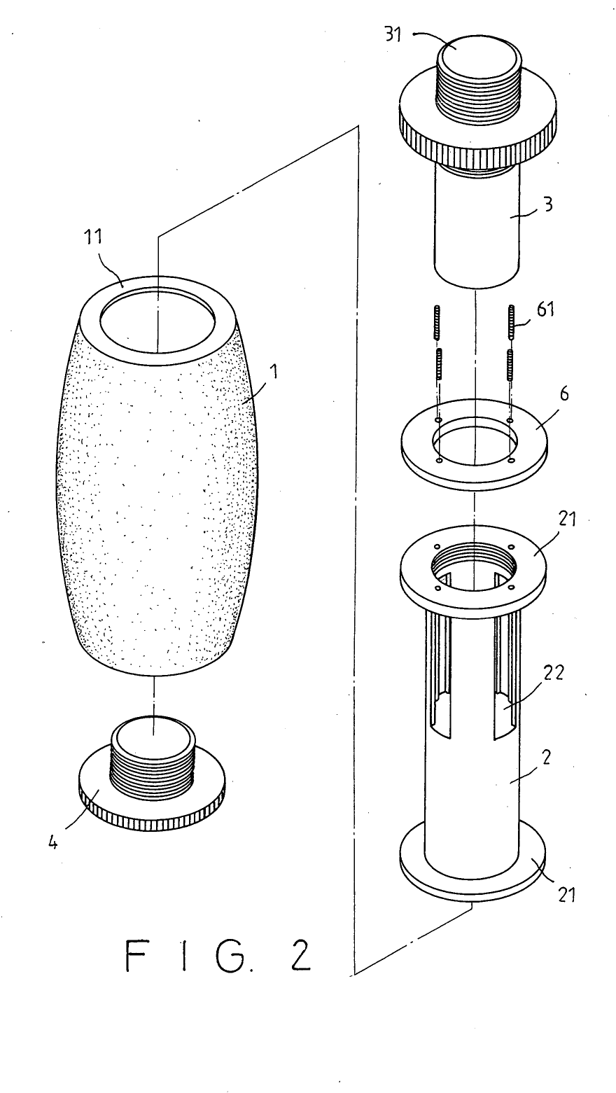

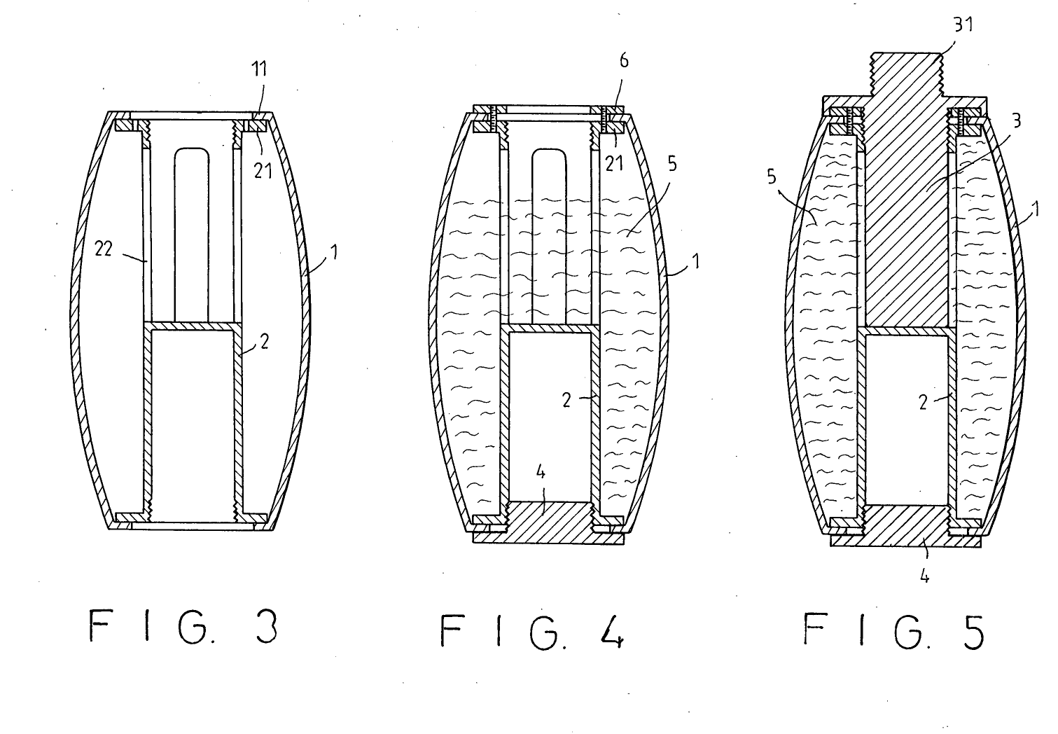

Please refer to FIG. 1 and 2; the present invention relates to a soft handle, which includes a soft shell (1) and a special shaft (2) engaging with an upper connecting rod (3) and a bottom cap (4). Space in the hollow shell (1) is fulfilled with sticky liquid (5) that provides a soft contact for users comfortably. The shell (1) has top and bottom ends with inward flanges (11) and the shaft (2) has both, ends with outward rims (21). When the shaft (2) is placed in the shell (1), the rims (21) of the shaft (2) are positioned in the related flanges (11), as shown in FIG. 3.

Further referring to FIG. 4 and 5, the bottom cap (4) connects with lower end of the shaft (2) and clips the lower flange (11) with the lower rim (21). An annular ring (6) is provided on top end of the shell (1) to engage with the top rim (21) of the shaft (2) by screws (61), meanwhile clipping the top flange (11) of the shell. The shaft (2) has its upper side with several slots (22) for allowing the sticky liquid (5) passing through when it is injected from the opening of the shaft (2). The liquid (5) is therefore flowed in the hollow space of the shell (1), as shown in FIG. 4. As the connecting rod (3) is engaged with the shaft (2), the liquid (5) will be squeezed and full of in the inner space of the shell (1), as shown in FIG. 5.

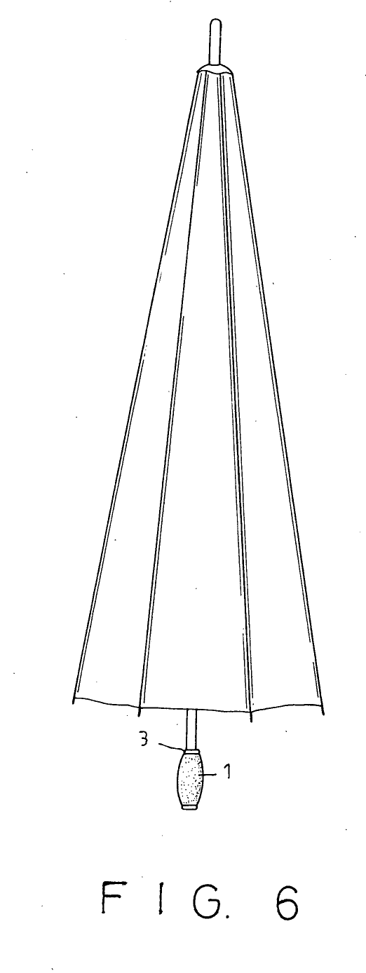

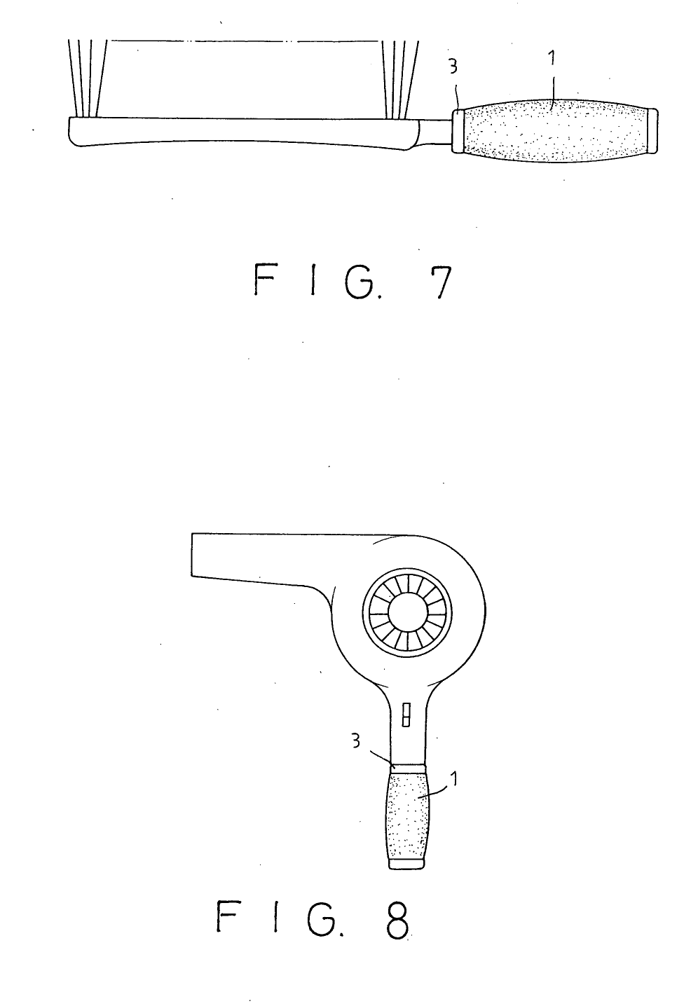

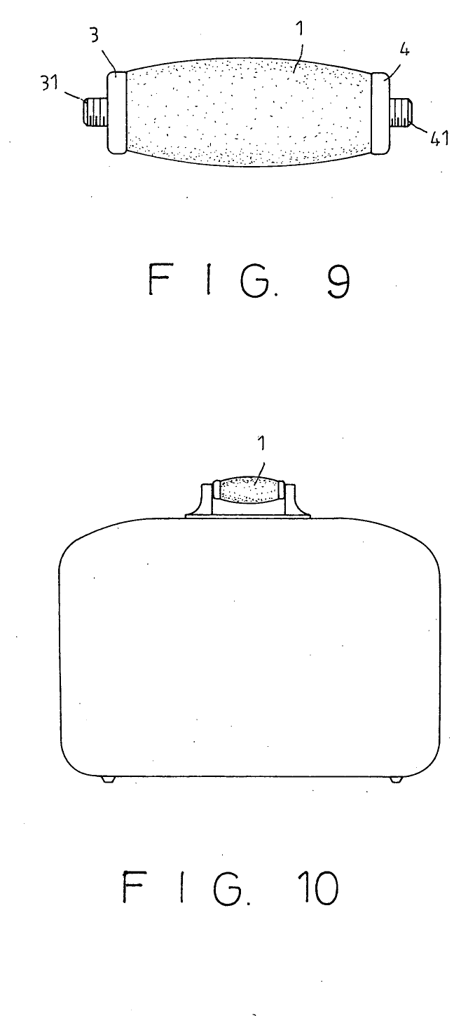

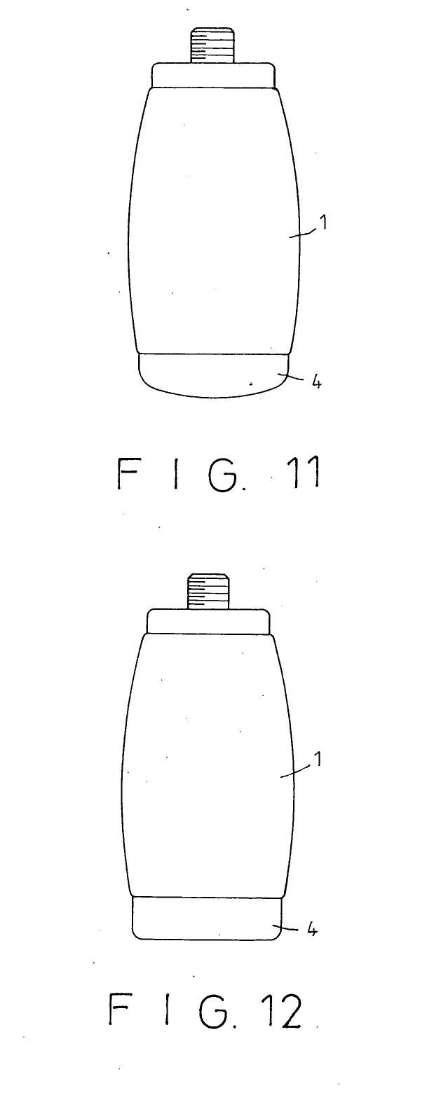

Under above assembly, the present invention can use a threaded head (31) on the connecting rod (3) to connect with other products, such as shown in FIGS. 6 to 8, including an umbrella, a comb, or a hair drier. Since the shell (1) with inner sticky liquid (12) is very soft, the products with the handle of the present invention can be used comfortable even a long time use. In FIGS. 9 and 10, the handle of the present invention has also a threaded head (41) on bottom cap (4) for applying on a brief case that will be another utilized embodiment. Moreover, the bottom cap (4) can be modified to be a ball cap (FIG. 15), or a cylinder cap (FIG. 16) as desired for use in different situations.

In above description, they are only embodiments to illustrate our embodiment and are not to limit the scope of this application. Any modified embodiments with similar merits are also claimed according to the present invention.

I claim:

1. A soft handle including a soft shell and a special shaft engaging with an upper connecting rod and a bottom cap, space in the hollow shell being fulfilled with sticky liquid, wherein the shell has top and bottom ends with inward flanges and the shaft has both ends with outward rims; the shaft is placed in the shell, while the rims of the shaft are positioned in the related flanges, the bottom cap connecting with lower end of the shaft and clipping the lower flange with the lower rim, an annular ring provided on top end of the shell to engage with the top rim of the shaft by screws, meanwhile clipping the top flange of the shell; the shaft having its upper side with several slots for allowing the sticky liquid passing through when it is injected from the opening of the shaft; the liquid being therefore flowed in the hollow space of the shell, and the connecting rod being engaged with the shaft, the liquid being squeezed and full of in the inner space of the shell that becomes a soft character for handling.
